(19) United States
(12) Patent Application Publication
(10) Pub. No.: US 2015/0160371 A1
(43) Pub. Date: Jun. 11, 2015

(54) GPU ACCELERATED DEFLATION IN GEOMECHANICS SIMULATOR

(71) Applicant: SCHLUMBERGER TECHNOLOGY CORPORATION, Sugar Land, TX (US)

(72) Inventors: Tom Jonsthovel, Abingdon (GB); Paul Woodhams, Abingdon (GB)

(21) Appl. No.: 14/535,459

(22) Filed: Nov. 7, 2014

Related U.S. Application Data
(60) Provisional application No. 61/912,653, filed on Dec. 6, 2013.

(51) Int. Cl. G01V 99/00; G06F 17/50; G06F 17/16

(52) U.S. Cl. CPC G01V 99/005; G06F 17/16; G06F 17/5009

(57) ABSTRACT

Using a CPU and at least one GPU to simulate geomechanical reservoir deformation due to a change in force on the reservoir is presented. An example method includes obtaining a stiffness matrix representing a finite element mesh for a grid of the reservoir, obtaining a load vector representing the change in force, determining a displacement vector representing the deformation of the reservoir, by computing, as a setup process apart from a conjugate gradient solver iteration, and by the CPU and the at least one GPU, at least a portion of a deflation operator and iterating, by the CPU and the at least one GPU, a conjugate gradient solver applied to a system of linear equations defined by at least the deflation operator, the stiffness matrix, the load vector, and the displacement vector, such that a deflated solution corresponding to the displacement vector is produced.

### RELATED APPLICATION

The present application claims priority to and the benefit of U.S. Provisional Patent Application No. 61/912,653, filed Dec. 6, 2013, the entirety of which is hereby incorporated by reference.

### BACKGROUND

Geomechanical simulators construct finite element meshes from a reservoir grid and, by modeling the elastic, plastic, and viscous behavior of materials represented by grid elements, compute the deformations for changes in the external or internal forces. Such simulators generally include a linear solver, such as a Conjugate Gradient (CG) solver. An example of a CG solver is the Deflated Preconditioned Conjugate Gradient (DPCG) solver.

In geomechanical simulations, the linear solver may take O(10³) iterations to converge. Hence, the linear solver can dominate runtime, taking up to about 70-80% of the runtime in some cases.

### SUMMARY

According to some embodiments, a method of using an electronic central processing unit (CPU) and at least one electronic graphics processing unit (GPU) to perform a geomechanical simulation of a deformation of a reservoir due to a change in force on the reservoir is presented. The method includes obtaining a computer readable representation of a stiffness matrix (K) representing at least a finite element mesh for a grid of the reservoir. The method also includes obtaining a computer readable representation of a load vector (Δf) representing the change in force on the reservoir. The method also includes determining a displacement vector (Δu) representing the deformation of the reservoir due to the change in force on the reservoir. The determining includes: computing, as a setup process apart from a conjugate gradient solver iteration, and by the CPU and the at least one GPU, at least a portion of a deflation operator (P), and iterating, by the CPU and the at least one GPU, a conjugate gradient solver applied to a system of linear equations defined by at least the deflation operator (P), the stiffness matrix (K), the load vector (Δf), and the displacement vector (Δu), whereby a deflated solution (Δũ) corresponding to the displacement vector (Δu) is produced. The method also includes outputting the displacement vector (Δu).

Various optional features of the above embodiments include the following. The portion of the deflation operator may include a product (KZK⁻¹) of the stiffness matrix (K), a deflation matrix (Z), and an inverse of a coarse grid matrix (E). The computing at least a portion of the deflation operator may include computing, by the at least one GPU, a product (KZ) of the stiffness matrix (K) and the deflation matrix (Z). At least the deflation matrix (Z) may be electronically stored as a set of vectors, and the product (KZ) of the stiffness matrix (K) and the deflation matrix (Z) may be computed as a plurality of sparse matrix vector products. The at least one GPU can include a plurality of GPUs, the method further include: computing, by respective GPUs of the plurality of GPUs, a partial coarse grid matrix, such that a plurality of partial coarse grid matrices are obtained, and determining, by the CPU, the coarse grid matrix (E) based on the plurality of partial coarse grid matrices. The method can include computing, as a setup process apart from a conjugate gradient solver iteration, and by the CPU and the at least one GPU, a transpose (Z^{T}) of a deflation matrix (Z). The method can include storing, as a setup process apart from a conjugate gradient solver iteration, a transpose (Z^{T}) of a deflation matrix (Z) as a sparse matrix. The method can include updating coefficients of the deflation matrix (Z) using translation deflation vectors as a mask for scattering rotation deflation vector coefficients. The system of linear equations n further include a preconditioner. The outputting can include at least one of: outputting to a reservoir model, and causing a representation of the deformation of the reservoir to be displayed.

According to some embodiments, a system for performing a geomechanical simulation of a deformation of a reservoir due to a change in force on the reservoir is presented. The computing system includes: an electronic central processing unit (CPU), at least one electronic graphics processing unit (GPU), and persistent memory storing computer readable instructions, which, when executed by the computing system, cause the computing system to: obtain a computer readable representation of a stiffness matrix (K) representing at least a finite element mesh for a grid of the reservoir, obtain a computer readable representation of a load vector (Δf) representing the change in force on the reservoir, determine a displacement vector (Δu) representing the deformation of the reservoir due to the change in force on the reservoir by: computing, as a setup process apart from a conjugate gradient solver iteration, and by the CPU and the at least one GPU, at least a portion of a deflation operator (P), and by iterating, by the CPU and the at least one GPU, a conjugate gradient solver applied to a system of linear equations defined by at least the deflation operator (P), the stiffness matrix (K), the load vector (Δf), and the displacement vector (Δu), whereby a deflated solution (Δũ) corresponding to the displacement vector (Δu) is produced, and to output the displacement vector (Δu).

Various optional features of the above embodiments include the following. The portion of the deflation operator may include a product (KZE⁻¹) of the stiffness matrix (K), a deflation matrix (Z), and an inverse of a coarse grid matrix (E). The computing at least a portion of the deflation operator may include computing, by the at least one GPU, a product (KZ) of the stiffness matrix (K) and the deflation matrix (Z). At least the deflation matrix (Z) may be electronically stored as a set of vectors, and the product (KZ) of the stiffness matrix (K) and the deflation matrix (Z) may be computed as a plurality of sparse matrix vector products. The at least one GPU may include a plurality of GPUs, and the persistent memory may store further computer readable instructions, which, when executed by the computing system, cause the computing system to: compute, by respective GPUs of the plurality of GPUs, a partial coarse grid matrix, such that a plurality of partial coarse grid matrices are obtained, and determine, by the CPU, the coarse grid matrix (E) based on the plurality of partial coarse grid matrices. The persistent memory may store further computer readable instructions, which, when executed by the computing system, cause the computing system to compute, as a setup process apart from a conjugate gradient solver iteration, and by the CPU and the at least one GPU, a transpose (Z^{T}) of a deflation matrix (Z). The persistent memory may store further computer readable instructions, which, when executed by the computing system, cause the computing system to store, as a setup process apart from a conjugate gradient solver iteration, a transpose (Z^{T}) of a deflation matrix (Z) as a sparse matrix. The persistent memory may store further computer readable instructions, which, when executed by the computing system, cause the computing system to update coefficients of the deflation matrix (Z) using translation deflation vectors as a mask for scattering rotation deflation vector coefficients. The system of linear equations may further include a preconditioner. The persistent memory may store further computer readable instructions, which, when executed by the computing system, cause the computing system to output the displacement vector (Δu) by at least one of: outputting to a reservoir model, and causing a representation of the deformation of the reservoir to be displayed.

According to some embodiments, a computer readable medium including computer readable instructions is presented. The computer readable instructions, when executed by a computing system comprising a central processing unit (CPU) and at least one graphics processing unit (GPU), cause the computing system to obtain a computer readable representation of a stiffness matrix (K) representing at least a finite element mesh for a grid of the reservoir, obtain a computer readable representation of a load vector (Δf) representing the change in force on the reservoir, determine a displacement vector (Δu) representing the deformation of the reservoir due to the change in force on the reservoir by: computing, as a setup process apart from a conjugate gradient solver iteration, and by the CPU and the at least one GPU, at least a portion of a deflation operator (P), and by iterating, by the CPU and the at least one GPU, a conjugate gradient solver applied to a system of linear equations defined by at least the deflation operator (P), the stiffness matrix (K), the load vector (Δf), and the displacement vector (Δu), whereby a deflated solution (Δũ) corresponding to the displacement vector (Δu) is produced, and output the displacement vector (Δu).

It will be appreciated that the foregoing summary is merely intended to introduce a subset of the subject matter discussed below and is, therefore, not limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. The patent or application file contains at least one drawing executed in color. Copies of this patent or patent application publication with color drawing(s) will be provided by the Office upon request and payment of the necessary fee. In the figures:

FIG. 1 illustrates a reservoir grid and boundary, according to an embodiment.

FIG. 2 illustrates a multi-GPU implementation of u=Z^{T}w, according to an embodiment.

FIG. 3 illustrates a flowchart of a method, according to an embodiment.

FIG. 4 illustrates a plot of comparison of solve time for CPU CG, GPU CG, and GPU DPCG solvers, according to an embodiment.

FIG. 5 illustrates a plot depicting GPU solver scalability, according to an embodiment.

FIG. 6 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

The DPCG method can reduce the number of iterations required, as compared to the normal CG method by, for example, approximately a factor of three, at least in geomechanics applications. The DPCG includes a projection process. During the projection process, deflation vectors are specified. The optimal choice of these vectors is an approximation of the rigid body modes of the model. These are the translations and rotations of the model.

The DPCG method may employ sparse matrix-vector multiplications and dense vector operations. The projection process may be defined as:

P=I−KZE⁻¹Z^{T},

where, I is the identity matrix, K is the stiffness matrix, Z is the deflation matrix that contains the deflation vectors and E=Z^{T}KZ is the coarse grid matrix. The method of the present disclosure may move computation outside of the DPCG loop to ensure the routines called and data structures operated on during the projection map well to the graphics processing unit (GPU) architecture. The method for performing the projection process may include, among other things:

Calculating KZE⁻¹ upfront and storing as a series of vectors.

Creating Z^{T} from Z and storing as a sparse matrix.

Optimizing of the Z^{T} setup to minimize data transfers by setting up the matrix sparsity once and using the translation deflation vectors as a mask for scattering the rotation deflation vector coefficients.

As such, the present method may ensure the deflation projection process is efficiently run by the GPU.

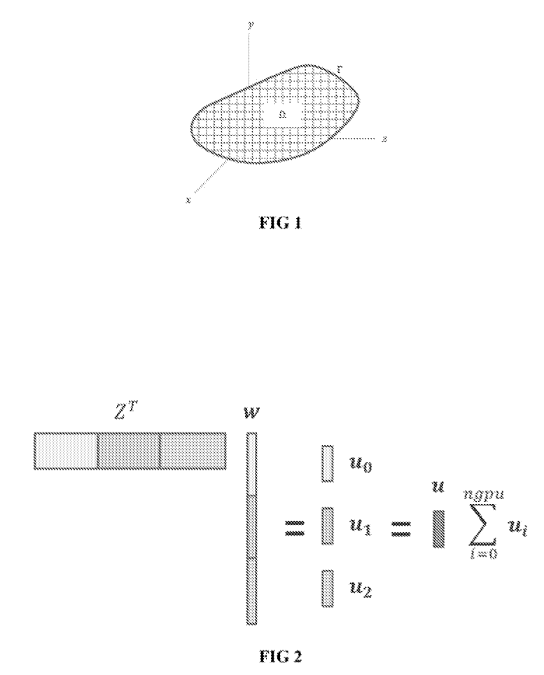

FIG. 1 illustrates an example of a grid and boundary of a reservoir represented by Ω and Γ respectively. The governing linearized equations may be discretized by linear finite elements, such that each element has eight corner nodes, with three degrees of freedom per node: displacement u in x-, y-, and z-direction. This yields stiffness matrix K∈ [symbol] ^{n×n} following linear system,

KΔu=Δf, (1)

with displacement vector Δu∈ [symbol] ⁿ and load vector Δf∈ [symbol] ⁿ. The row and column dimension n of matrix K depends on the number of grid cells and the boundary conditions. Due to the nature of the underlying equations, the stiffness matrix may be symmetric and positive definite; hence,

∀x, Kx=λx, λ>0.

For symmetric, positive, definite matrices, the Preconditioned Conjugate Gradient (PCG) method may be employed. The convergence rate of the PCG method may be bounded by the effective condition number and thus indirectly by the minimum and maximum eigenvalues of matrix K. After k iterations of PCG, the error may be bounded by:

$${‖ Δ u - Δ {u}_{k} ‖}_{K} \leq 2 {‖ Δ u - Δ {u}_{0} ‖}_{K} {( \frac{\sqrt{{κ}_{eff} ( K )} - 1}{\sqrt{{κ}_{eff} ( K )} + 1} )}^{k} , \qquad ( 2 )$$

where,

$${κ}_{eff} ( K ) = \frac{{λ}_{n}}{{λ}_{m + 1}} ,$$

is the effective condition number of K and λₙ, λₘ₊₁ are the largest and smallest non-zero eigenvalues respectively. In some instances, the convergence rate of PCG may be improved by reducing the effective condition number.

Changes in the largest and smallest non-zero eigenvalues of the stiffness matrix K have a direct effect on the number of iterations of PCG to convergence. The largest eigenvalue of matrix K may grow with the number of elements. Hence, bigger meshes may lead to ill-conditioned systems. In general, the largest eigenvalue may be mapped close to 1 by applying an effective preconditioner to matrix K. The smallest eigenvalues are influenced by the underlying physics, and the (near-)null space of matrix K in particular.

In 3D finite elements the (near)-null space of the matrix K is equal to the rigid body modes of the modeled body. Rigid body modes are generally defined as the displacements that do not deform the body, hence zero change in force. In 3D, rigid body modes are defined by the translations and rotations. For example, the following solution vector Δuⁱ for an arbitrary element i with eight nodes may be employed:

Δuⁱ=[u_{1,x}u_{1,y}u_{1,z} . . . u_{8,x}u_{8,y}u_{8,z}]^{T}. (3)

The rigid body modes Zⁱ∈ [symbol] ^{24×6} for element i are defined as,

$${Z}^{i} = {[ \begin{matrix}1 & 0 & 0 & … & 1 & 0 & 0 \\ 0 & 1 & 0 & … & 0 & 1 & 0 \\ 0 & 0 & 1 & … & 0 & 0 & 1 \\ 0 & {z}_{1} & - {y}_{1} & … & 0 & {z}_{8} & - {y}_{8} \\ - {z}_{1} & 0 & {x}_{1} & … & - {z}_{8} & 0 & {x}_{8} \\ {y}_{1} & - {x}_{1} & 0 & … & {y}_{8} & - {x}_{8} & 0\end{matrix} ]}^{T} , \qquad ( 4 )$$

where, xⱼ, yⱼ and zⱼ represent the spatial coordinates of node j.

In general, the matrix K does not have a null space, because otherwise the matrix would be singular. However, the rigid body modes of the reservoir are close to the eigenvectors that correspond to the smallest non-zero eigenvalues. In the following section we explain how to remove the rigid body modes from the solution process by applying deflation.

### Deflation Theory

The deflation operator P may be defined as:

P=I−KZ(Z^{T}KZ)⁻¹Z^{T}=I−KZE⁻¹Z^{T}, (5)

where deflation vectors Z∈ [symbol] ^{n×6}. Applying the deflation operator P to the linear system of Equation (1) yields:

PKΔũ=PΔf. (6)

Equation (6) may be solved and the non-unique deflated solution Δũ may be transformed to obtain an unique solution Δu for Equation (1):

Δu=ZE⁻¹Z^{T}Δf+P^{T}Δũ. (7)

For a splitting K=C+R such that C and R are positive semi-definite matrices and N(C)=span{Z}, the effective condition number of PK is:

$${κ}_{eff} ( PK ) = \frac{{λ}_{n} ( K )}{{λ}_{m + 1} ( C )} . \qquad ( 8 )$$

The effective condition number of PK is reduced as the smallest non-zero eigenvalue of C defined by λₘ₊₁ (C) increases. By taking the rigid body modes of the reservoir Ω as deflation vectors we remove the corresponding unfavorable smallest eigenvalues from the spectrum of PK and hence improve the convergence of PCG.

As mentioned above, to attack the upper part of the spectrum of matrix K, a preconditioner may be applied to Equation (6), yielding:

M⁻¹PKΔũ=M⁻¹PΔf. (9)

Equation (9) equals:

PM⁻¹KΔũ=PM⁻¹Δf. (10)

Preconditioners are approximations of the original, preconditioned matrix. In this application, applying the Jacobi preconditioner, M=diag(K) may be sufficient. Although Jacobi may be considered a weak preconditioner, it is generally parallel by nature and, for at least this reason, may be suitable for implementation on the GPU.

The Deflated Preconditioned Conjugate Gradient algorithm, according to an embodiment, is given in Algorithm (1), as follows:

Algorithm (1)

```
Select Δũ₀. Compute \tilde{r}₀ = P(Δf − KΔũ₀), set \tilde{p}₀ = \tilde{r}₀.
Solve My₀ = \tilde{r}₀ and set p₀ = y₀.
for j = 0,1, . . . until convergence do
  \tilde{w}ⱼ = PKpⱼ,
  ${α}_{j} = \frac{{\tilde{r}}_{j}^{T} {y}_{j}}{{\tilde{w}}_{j}^{T} {p}_{j}} ,$
  Δũⱼ₊₁ = Δũⱼ + αⱼpⱼ,
  \tilde{r}ⱼ₊₁ = \tilde{r}ⱼ − αⱼ\tilde{w}ⱼ,
  Solve Myⱼ₊₁ = \tilde{r}ⱼ₊₁,
  ${β}_{j} = \frac{{\tilde{r}}_{j + 1}^{T} {y}_{j + 1}}{{\tilde{r}}_{j}^{T} {p}_{j}} ,$
  pⱼ₊₁ = yⱼ₊₁ + βⱼpⱼ,
end for
  Δu = ZE⁻¹Z^{T}Δf + P^{T}Δũ.
```

### Deflation on GPU

To implement the DPCG algorithm as detailed in Algorithm (1), a set of software components, both data structures and functions, may be employed. For example, sparse matrices and vectors may be employed as core data structures. The sparse matrix format may be chosen such that maximum performance can be achieved in the sparse-matrix vector multiplication (SpMV). Choices of sparse matrix format include CSR, HYB or ELL. Other functions include vector operations such as dot products and arithmetic operations.

Maximizing deflation performance may include splitting the implementation into two phases: setup and solve. These phases may be used to determine \tilde{w}ⱼ=PKpⱼ in Algorithm (1), above. The setup may be called before entering the CG loop (e.g., the for/do loop in Algorithm (1)) while the solve may be called every CG iteration. The solve may be optimized for efficiency, which may be achieved at least in part by ensuring as much calculation as possible was done upfront in the setup phase and that any functions and data structures used in the solve phase suited the GPU architecture.

Table 1 shows the components of the setup phase including the data structures used and whether the computation is performed on the CPU or GPU.

TABLE 1
DPCG Setup

| CPU | | GPU |
|---|---|---|
| K (CSR), Z (vec[ ]) | -> | K (CSR), Z (vec[ ]) |
| | | convert K (CSR) to K (HYB) |
| | | compute KZ (vec[ ]) |
| E (dense matrix) | <- | compute E = Z^{T} KZ (dense matrix) |
| all reduce Σ_{ngpu} E | | |
| compute E⁻¹ (dense | -> | compute KZE⁻¹ (vec[ ]) |
| matrix) | | |
| | | compute Z^{T} sparsity pattern |
| | | copy Z^{T} coefficients |

As will be appreciated, the deflation vectors Z may be supplied as vectors rather than a matrix. Thus, the computation of KZ may be completed as a series of sparse matrix vector products rather than a sparse matrix multiplication; accordingly, the results can again be stored as vectors. When computing E=Z^{T}KZ, Z^{T} may not be formed; instead, the vector Z may be employed and E computed as a series of inner products. When running on multiple GPUs, each GPU may compute a partial E, since the matrices and vectors have been distributed by row across the available GPUs. Each GPU may compute a partial E, with the results from each GPU being summed on the CPU. Finally KZE⁻¹ may be computed as a series of vector AXPY (Alpha X Plus Y) calls.

The KZE⁻¹ used in the solve phase when computing w=w−KZE⁻¹u may be formed as a series of vectors. The computation then includes a series of vector operations, which are highly efficient on the GPU. An implementation may prioritize an efficient solve phase over additional computation in the setup phase. It should be noted that in prior art DPCG implementations, KZE⁻¹ would not be computed upfront and this is a GPU specific decision.

Contrary to how the deflation vectors are used in computing KZE⁻¹, when considering Z^{T}, sparsity may be exploited by storing Z^{T} as a sparse matrix. For geomechanics, the deflation vectors are formed in such a way that for each of the translations two thirds of the vector is empty and for each of the rotations one third of the vector is empty. Exploiting this sparsity ensures that computation of u=Z^{T}w in the solve phase has little or no redundant computation, which may yield an improved performance.

Further, the sparsity pattern of Z^{T} may not change through many calls to the DPCG solver. This may allow the setup of Z^{T} to be split into two parts: one to construct the matrix sparsity and another to update the matrix coefficients. The sparsity construction may be done once. On subsequent calls, the matrix coefficients may be updated. The coefficients may change for the rotation deflation vectors, so their matrix coefficients may be updated. The updating of the coefficients may be done as a scatter operation with the corresponding translation deflation vector being used as a mask. The mask applied is that if there is a value in the translation vector, then no value should be in the corresponding rotation vector.

With this implementation of the setup, the solve phase, e.g., as outlined in Table 2, may provide good performance when operating on the GPU.

TABLE 2
DPCG solve

| CPU | | GPU |
|---|---|---|
| | | w (vec) |
| | | compute u = Z^{T} w (vec) |
| u (vec) | <- | u (vec) |
| all reduce Σ_{ngpu} u | -> | update u (vec) |
| | | compute w = w − KZE⁻¹ u (vec) |

A multi-GPU implementation may employ data structures that allow the full system to be distributed across multiple GPUs and functions to operate on these distributed data structures. Additions may include a vector with a halo for the SpMV operations, a communication layer for updating the halo, and a reduction operation for dot products.

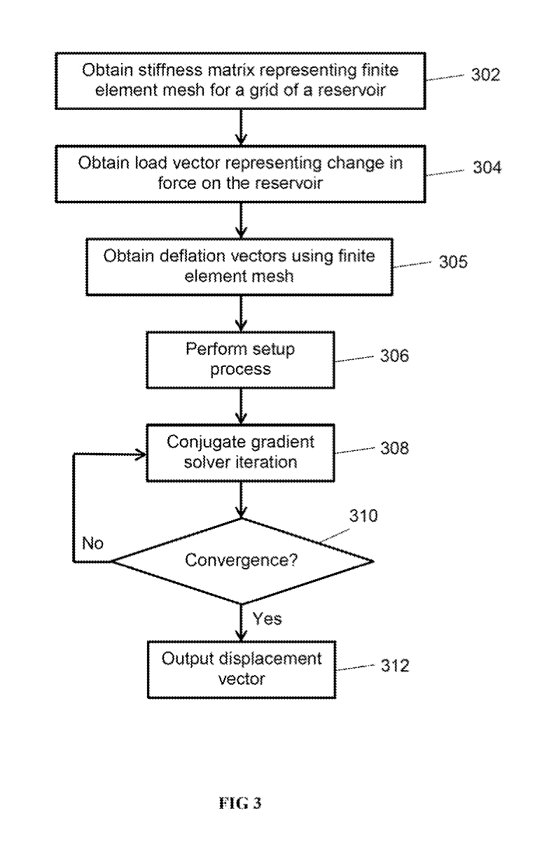

A row based distribution may be used to distribute the full system across multiple GPUs. In many cases of the algorithm, no changes were required, as any GPU-GPU communications may be handled by a standard or commercial library. There may be, however, one change required in the deflation solve phase; specifically, the calculation of u=Z^{T}w may be changed in the deflation solve phase. The vector w follows the row based distribution and therefore Z^{T} needs to be distributed based on columns as shown in FIG. 2. Each GPU then computes a partial u and the results are combined on the CPU.

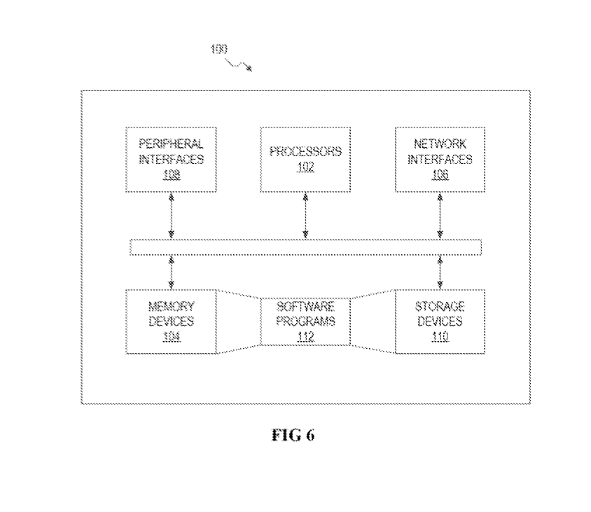

FIG. 3 is a flowchart depicting a method according to some embodiments. The method of FIG. 3 may be implemented using a computer system that includes at least one CPU and at least one GPU. For example, the method may be implemented using the system described below in reference to FIG. 6.

At block 302, the method obtains a computer-readable representation of a stiffness matrix representing a finite element mesh for a grid of a reservoir. The method may obtain such a representation by receiving it over a network, by receiving input from a user through a computer interface, or by retrieving it from storage. Other techniques for obtaining the representation are possible.

At block 304, the method obtains a computer-readable representation of a load vector, itself representing a change in force on the reservoir. Similar to block 302, the method may obtain the representation of the load vector by receiving it over a network, by receiving input from a user through a computer interface, or by retrieving it from storage. Alternately, the method may obtain the vector by measurement. Other techniques for obtaining the representation of the load vector are possible.

At block 305, the method obtains deflation vectors derived from the finite element mesh for the grid of the reservoir. The method may obtain the deflation vectors by retrieving a sparse matrix Z or its transpose Z^{T} as described herein, from electronic (e.g. persistent) storage, by receiving user input, or over a network.

At block 306, the method performs a setup process. The setup process may be as described above in reference to Table 1. For example, the setup process may include calculating and storing KZE⁻¹ and Z^{T} as described herein. The setup process may utilize computing hardware that includes at least one CPU and at least one GPU.

At block 308, the method performs a CG solver iteration, e.g., a DPCG iteration. The iteration may be an iteration according to Algorithm (1) described herein, and may include a calculation according to Table 2 as part of the iteration. The iteration may utilize computing hardware that includes a CPU and one or more GPUs.

At block 310, the method determines whether the CG iteration process has converged. Convergence may be determined by, for example, determining that a difference between the results of a prior iteration and the results of a current iteration is less than a threshold value, e.g., effective Cauchy convergence. Other convergence detection techniques may be used in addition or in the alternative. If no convergence is determined, then the process branches back to block 308. Otherwise, the process branches to block 312.

At block 312, the process outputs a displacement vector. The output may be to a user in the form of data or in graphical form. Alternately, or in addition, the output may be to a program module that processes the output, e.g., to generate a graphical display. Alternately, or in addition, the output may be to an electronic memory device.

### Examples

One or more aspects of the foregoing disclosure, including the method described therein, may be further illustrated by reference to the following non-limiting examples.

The present examples illustrate performance results for a DPCG-GPU implementation. The hardware setup for performing these tests is given in Error! Reference source not found.Error! Reference source not found. The CPU implementation we used for comparison is an MPI parallelized CG solver that is currently used.

TABLE 3
Experimental Hardware Profile

| | | Peak double precision FP | Memory |
|---|---|---|---|
| Hardware | #Cores | performance (Gflops) | bandwidth (GB/s) |
| Intel SandyBridge | 16 | ~200 | ~37 |
| NVIDIA Kepler | 2688 | 1310 | 250 |
| K20X | | | |
| NVIDIA Fermi | 512 | 665 | 177 |
| M2090 | | | |

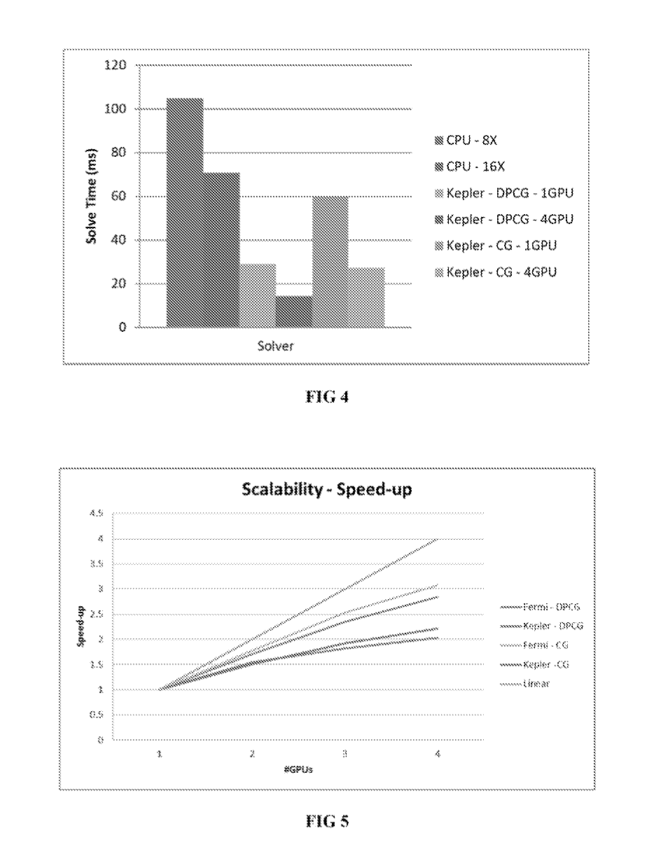

FIG. 4 below shows the performance results from solving a single linear system with 932,818 unknowns and 73,131,214 non-zero coefficients. The linear system being solved corresponds to a finite element discretization of PDEs on a 3D structured grid. The large number of non-zero coefficients is because the system solved is a block system but stored as a scalar system. The figure clearly shows that the CG implementation on a single GPU is comparable with the 16-way CPU implementation. However the best performance is seen when combining both the GPU implementation and the deflation algorithm, where on a single Kepler GPU a speed-up of 2.4 is seen while on four Kepler GPUs a speed-up of 4.7 is achieved.

In Error! Reference source not found. 5, the scalability of the DPCG implementation when running the test matrix on various numbers of Kepler or Fermi GPUs is illustrated. When running on the Kepler K20X the scalability begins to drop away after two GPUs while on Fermi we scale to 3 GPUs before scalability worsens. In general, a performance improvement may be realized by adding GPUs all the way up to four GPUs.

Embodiments of the disclosure may also include one or more systems for implementing one or more embodiments of the method. FIG. 6 illustrates a schematic view of such a computing or processor system 100, according to an embodiment. The processor system 100 may include one or more processors 102 of varying core configurations (including multiple cores) and clock frequencies. The one or more processors 102 may be operable to execute instructions, apply logic, etc. It will be appreciated that these functions may be provided by multiple processors or multiple cores on a single chip operating in parallel and/or communicably linked together. In at least one embodiment, the one or more processors 102 may be or include one or more GPUs, as well as one or more CPUs.

The processor system 100 may also include a memory system, which may be or include one or more memory devices and/or computer-readable media 104 of varying physical dimensions, accessibility, storage capacities, etc. such as flash drives, hard drives, disks, random access memory, etc., for storing data, such as images, files, and program instructions for execution by the processor 102. In an embodiment, the computer-readable media 104 may store instructions that, when executed by the processor 102, are configured to cause the processor system 100 to perform operations. For example, execution of such instructions may cause the processor system 100 to implement one or more portions and/or embodiments of the method 100 described above.

The processor system 100 may also include one or more network interfaces 106. The network interfaces 106 may include any hardware, applications, and/or other software. Accordingly, the network interfaces 106 may include Ethernet adapters, wireless transceivers, PCI interfaces, and/or serial network components, for communicating over wired or wireless media using protocols, such as Ethernet, wireless Ethernet, etc.

The processor system 100 may further include one or more peripheral interfaces 108, for communication with a display screen, projector, keyboards, mice, touchpads, sensors, other types of input and/or output peripherals, and/or the like. In some implementations, the components of processor system 100 need not be enclosed within a single enclosure or even located in close proximity to one another, but in other implementations, the components and/or others may be provided in a single enclosure.

The memory device 104 may be physically or logically arranged or configured to store data on one or more storage devices 110. The storage device 110 may include one or more file systems or databases in any suitable format. The storage device 110 may also include one or more software programs 112, which may contain interpretable or executable instructions for performing one or more of the disclosed processes. When requested by the processor 102, one or more of the software programs 112, or a portion thereof, may be loaded from the storage devices 110 to the memory devices 104 for execution by the processor 102.

Those skilled in the art will appreciate that the above-described componentry is merely one example of a hardware configuration, as the processor system 100 may include any type of hardware components, including any necessary accompanying firmware or software, for performing the disclosed implementations. The processor system 100 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 100 may be used to execute programs according to instructions received from another program or from another processor system altogether. Similarly, commands may be received, executed, and their output returned entirely within the processing and/or memory of the processor system 100. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method of using an electronic central processing unit (CPU) and at least one electronic graphics processing unit (GPU) to perform a geomechanical simulation of a deformation of a reservoir due to a change in force on the reservoir, the method comprising:
obtaining a computer readable representation of a stiffness matrix (K) representing at least a finite element mesh for a grid of the reservoir;
obtaining a computer readable representation of a load vector (Δf) representing the change in force on the reservoir;
determining a displacement vector (Δu) representing the deformation of the reservoir due to the change in force on the reservoir, wherein the determining comprises:
computing, as a setup process apart from a conjugate gradient solver iteration, and by the CPU and the at least one GPU, at least a portion of a deflation operator (P); and
iterating, by the CPU and the at least one GPU, a conjugate gradient solver applied to a system of linear equations defined by at least the deflation operator (P), the stiffness matrix (K), the load vector (Δf), and the displacement vector (Δu), whereby a deflated solution (Δũ) corresponding to the displacement vector (Δu) is produced; and
outputting the displacement vector (Δu).

2. The method of claim 1, wherein the portion of the deflation operator comprises a product (KZE⁻¹) of the stiffness matrix (K), a deflation matrix (Z), and an inverse of a coarse grid matrix (E).

3. The method of claim 2, wherein the computing at least a portion of the deflation operator comprises computing, by the at least one GPU, a product (KZ) of the stiffness matrix (K) and the deflation matrix (Z).

4. The method of claim 3, wherein at least the deflation matrix (Z) is electronically stored as a set of vectors, and wherein the product (KZ) of the stiffness matrix (K) and the deflation matrix (Z) is computed as a plurality of sparse matrix vector products.

5. The method of claim 2, wherein the at least one GPU comprises a plurality of GPUs, the method further comprising:
computing, by respective GPUs of the plurality of GPUs, a partial coarse grid matrix, whereby a plurality of partial coarse grid matrices are obtained; and
determining, by the CPU, the coarse grid matrix (E) based on the plurality of partial coarse grid matrices.

6. The method of claim 2, further comprising computing, as a setup process apart from a conjugate gradient solver iteration, and by the CPU and the at least one GPU, a transpose (Z^{T}) of a deflation matrix (Z).

7. The method of claim 2, further comprising storing, as a setup process apart from a conjugate gradient solver iteration, a transpose (Z^{T}) of a deflation matrix (Z) as a sparse matrix.

8. The method of claim 7, further comprising updating coefficients of the deflation matrix (Z) using translation deflation vectors as a mask for scattering rotation deflation vector coefficients.

9. The method of claim 1, wherein the system of linear equations further comprises a preconditioner.

10. The method of claim 1, wherein the outputting comprises at least one of: outputting to a reservoir model, and causing a representation of the deformation of the reservoir to be displayed.

11. A computing system for perform a geomechanical simulation of a deformation of a reservoir due to a change in force on the reservoir, the computing system comprising:
an electronic central processing unit (CPU);
at least one electronic graphics processing unit (GPU);
persistent memory storing computer readable instructions, which, when executed by the computing system, cause the computing system to:
obtain a computer readable representation of a stiffness matrix (K) representing at least a finite element mesh for a grid of the reservoir;
obtain a computer readable representation of a load vector (An representing the change in force on the reservoir;
determine a displacement vector (Δu) representing the deformation of the reservoir due to the change in force on the reservoir by:
computing, as a setup process apart from a conjugate gradient solver iteration, and by the CPU and the at least one GPU, at least a portion of a deflation operator (P); and
iterating, by the CPU and the at least one GPU, a conjugate gradient solver applied to a system of linear equations defined by at least the deflation operator (P), the stiffness matrix (K), the load vector (Δf), and the displacement vector (Δu), whereby a deflated solution (Δũ) corresponding to the displacement vector (Δu) is produced; and
output the displacement vector (Δu).

12. The system of claim 11, wherein the portion of the deflation operator comprises a product (KZE⁻¹) of the stiffness matrix (K), a deflation matrix (Z), and an inverse of a coarse grid matrix (E).

13. The system of claim 12, wherein the computing at least a portion of the deflation operator comprises computing, by the at least one GPU, a product (KZ) of the stiffness matrix (K) and the deflation matrix (Z).

14. The system of claim 13, wherein at least the deflation matrix (Z) is electronically stored as a set of vectors, and wherein the product (KZ) of the stiffness matrix (K) and the deflation matrix (Z) is computed as a plurality of sparse matrix vector products.

15. The system of claim 12, wherein the at least one GPU comprises a plurality of GPUs, the persistent memory storing further computer readable instructions, which, when executed by the computing system, cause the computing system to:
compute, by respective GPUs of the plurality of GPUs, a partial coarse grid matrix, whereby a plurality of partial coarse grid matrices are obtained; and
determine, by the CPU, the coarse grid matrix (E) based on the plurality of partial coarse grid matrices.

16. The system of claim 12, the persistent memory storing further computer readable instructions, which, when executed by the computing system, cause the computing system to:
compute, as a setup process apart from a conjugate gradient solver iteration, and by the CPU and the at least one GPU, a transpose (Z^{T}) of a deflation matrix (Z).

17. The system of claim 12, the persistent memory storing further computer readable instructions, which, when executed by the computing system, cause the computing system to:
store, as a setup process apart from a conjugate gradient solver iteration, a transpose (Z^{T}) of a deflation matrix (Z) as a sparse matrix.

18. The system of claim 17, the persistent memory storing further computer readable instructions, which, when executed by the computing system, cause the computing system to:
update coefficients of the deflation matrix (Z) using translation deflation vectors as a mask for scattering rotation deflation vector coefficients.

19. The system of claim 11, wherein the system of linear equations further comprises a preconditioner.

20. The system of claim 11, the persistent memory storing further computer readable instructions, which, when executed by the computing system, cause the computing system to output the displacement vector (Δu) by at least one of: outputting to a reservoir model, and causing a representation of the deformation of the reservoir to be displayed.

21. A computer readable medium comprising computer readable instructions, which, when executed by a computing system comprising a central processing unit (CPU) and at least one graphics processing unit (GPU), cause the computing system to:
obtain a computer readable representation of a stiffness matrix (K) representing at least a finite element mesh for a grid of the reservoir;
obtain a computer readable representation of a load vector (Δf) representing the change in force on the reservoir;
determine a displacement vector (Δu) representing the deformation of the reservoir due to the change in force on the reservoir by:
computing, as a setup process apart from a conjugate gradient solver iteration, and by the CPU and the at least one GPU, at least a portion of a deflation operator (P); and
iterating, by the CPU and the at least one GPU, a conjugate gradient solver applied to a system of linear equations defined by at least the deflation operator (P), the stiffness matrix (K), the load vector (Δf), and the displacement vector (Δu), whereby a deflated solution (Δũ) corresponding to the displacement vector (Δu) is produced; and
output the displacement vector (Δu).
